(19) United States
(12) Patent Application Publication
(10) Pub. No.: US 2004/0229020 A1
(43) Pub. Date: Nov. 18, 2004

(54) Corrosion resistant tile and protective tiling system

(76) Inventor: Paul Timothy LaBorde, Slidell, LA (US)

Correspondence Address: MICHAEL D CARBO, PLC, 700 WHITNEY BANK BUILDING, 228 ST CHARLES AVENUE, NEW ORLEANS, LA, 70130, US

(21) Appl. No.: 10/438,116

(22) Filed: May 14, 2003

(51) Int. Cl. B32B 23/02

(52) U.S. Cl. 428/192

(57) ABSTRACT

A corrosion resistant tile and a protective tiling system comprising polyurea or polyvinyl chloride tiles having notched or grooved perimeter end surfaces, either z-shaped or curvilinear. Adjacent end surfaces of adjacent tiles form a reservoir for receiving joint or seam filler which acts to seal out contaminants from substrates on which the tiles are placed.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

(1) Field of the Invention

This invention relates to a tiling system for use in protecting structural or decorative surfaces, such as work decks, floors and walls, as well as other substrates. In particular, the present invention provides tiles or panels having grooves in end surfaces thereof to receive flexible joint and seam filler so that the tiles or panels can be joined end to end to cover or tile a surface or substrate.

(2) Description of Related Art including Information Disclosed under 37 CFR 1.97 and 37 CFR 1.98

Conventional protective coating systems for use on work decks, floors, walls, and other substrates include industrial and marine paints and, more recently, polyurethane, urea and isocyanurate composites (referred to herein as polyurea or polyurea resin). Preparation of any surface to which a paint or other coating is to be applied is important for obtaining optimum service life. Sometimes surface preparation involving spraying or the use of abrasives is undesirable because of the labor intensive precautions that must be taken to avoid getting overspray and abrasives into nearby equipment or into the surrounding environment. Further, paint systems have limited resistance to impact, limited resistance to abrasion, and limited flexibility. Additionally, paint often becomes brittle or chalky and can develop microfractures with age due to repeated expansion and contraction of the substrate. Existing work-deck and heli-deck coating systems generally last between approximately five and ten years, depending on amount of use, exposure, frequency of maintenance and repair, and other factors.

More recently, composite technologies which utilize a mixture of polymers and other ingredients, synthetic and natural, have been used to cover structural surfaces. U.S. Pat. No. 5,053,274 to Jonas discloses composite single-unit and multi-unit tiles, each tile having an aromatic polyurea bottom layer and also having an aliphatic polyurea top layer having non-skid or other desirable characteristics. However, the tile system disclosed in Jonas, U.S. Pat. No. 5,053,274, uses a pre-formed grout line or indented border at the upper edge so that tiles may be abutted close to each other with a space remaining for grouting. The pre-formed grout line or indented border disclosed in U.S. Pat. No. 5,053,274 discloses grouting only at the surface indentation and is disadvantageous whenever the tiling system is subject to heavy use and impact, which tends to break the grout and allow contaminants to seep through the spaces between tiles to the surface or substrate below. Further, grout does not provide sufficient flexibility to provide corrosion resistance to ferrous substrates.

U.S. Pat. 6,284,841 to Friesner discloses a structural member comprising a multilayer tile comprising a polyurethane layer having channels as shown in FIG. 10 thereof.

U.S. Pat. 6,449,790 to Szekely discloses a transit boarding platform panel having a notched design for mating adjacent panels, as shown in FIG. 4 thereof. In FIG. 4 of U.S. Pat. 6,449,790, the interface between adjacent panels uses a shiplap configuration which creates a drainage channel beneath the joint between adjacent panels.

None of the above references discloses a polyurea or polyvinyl chloride tile having a groove in end surfaces thereof, disposed and configured as in the present invention, capable of receiving flexible joint and seam filler to promote corrosion resistance of a protective tiling system according to the present invention.

### BRIEF SUMMARY OF THE INVENTION

It is an object of the invention to provide a polyurea or polyvinyl chloride tile for use in a system for covering and protecting work decks, floors, walls, and other surfaces and substrates.

It is another object of the invention to provide precast tiles having grooves in end surfaces thereof to accommodate joint and seam filler which acts as a flexible gasket to keep out moisture and contaminants when the gaps between adjacent tiles are sealed by the use of the joint or seam filler.

Further, it is an object of the invention to provide interstitial sealing of adjacent tiles with filler that cannot be easily removed once it is placed and cured.

Thus, in accordance with the present invention, there is provided a precast polyurea tile having a bottom layer comprising an aromatic polyurea and a top layer comprising an aliphatic polyurea, the bottom layer having a groove in the sides thereof capable of accepting flexible joint and seam filler to act as a flexible gasket and to keep out moisture and contaminants when adjacent tiles are abutted and the adjacent grooves are filled with flexible polyurea or other joint or seam filler. The surface of the bottom layer preferably has troughs or channels to accommodate adhesive to adhere the tiles to a surface or substrate. Preferably the channels are not perpendicular to the substrate surface and are placed alternately at opposing angles to provide increased physical adhesion of the bottom layer to the adhesive. The top surface of the top layer preferably has a slip resistant surface.

Preferably the slip resistant top surface should be resistant to the effects of ultraviolet radiation, temperature changes and corrosive elements such as acids, alkalies, salts, phosphates, organic chemicals and solvents such as mineral spirits, gasoline, etc. The top surface should also be sufficiently hard to protect against abrasion, chipping, scratching or marring.

In uses not exposed to ultraviolet light, the top layer is not needed.

Further features of the invention will be described or will become apparent in the course of the following detailed description.

### BRIEF DESCRIPTION OF THE DRAWING:

FIG. 1 shows a perspective view of an embodiment of a tile according to the invention, showing a notch or groove in the perimeter thereof;

FIG. 2 shows a side view of two adjacent, bilayer tiles, showing a joint or seam filler reservoir formed by adjacent placement of the tiles;

FIG. 3 shows a side view of two adjacent, bilayer tiles, showing a z-shaped notch or groove in the perimeter edge thereof; and

FIG. 4 shows a side view of tiles according to the invention showing a corner joint for use in containment.

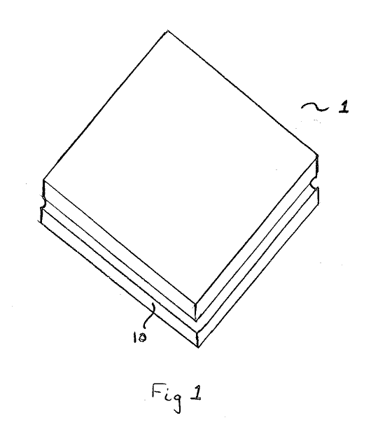

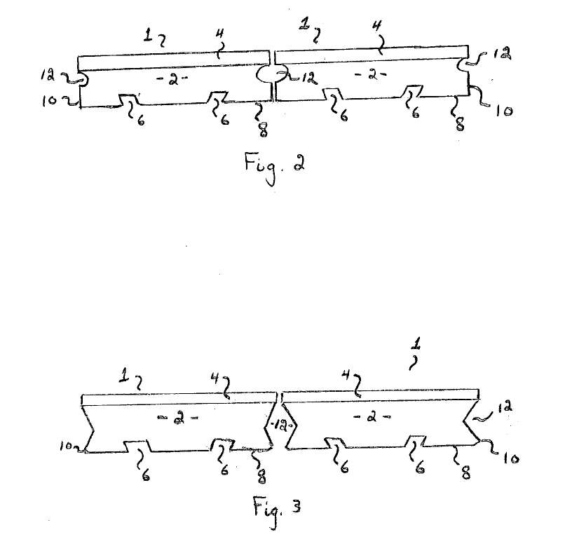

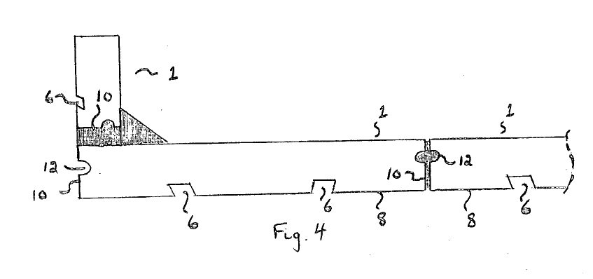

### DETAILED DESCRIPTION OF THE INVENTION

Embodiments of the invention include a rigid composite tile 1 of low brittleness comprising a base layer 2 of aromatic polyurea resin and a top layer 4 comprising aliphatic polyurea resin. The base layer 2 preferably has channels 6 on the bottom surface 8 to accommodate adhesive (not shown) to adhere the bottom surface 8 of a tile 1 to substrate.

The bottom layer 2 has a perimeter surface 10 containing a notch or groove 12. Preferably, the notch or groove 12 is disposed nearer to the top layer than to the bottom surface.

The tiles are thin, normally rectangular protective coverings used to cover and protect carbon steel, nonferrous metals, concrete, fiberglass, and wooden substrates of heli-decks, marine decks, work decks, floors, slabs and secondary containment slabs and walls, as well as other substrates. The tiles are intended to protect the substrate from corrosion, erosion, chemical exposure, impact, abrasion, and other environmental factors.

Preferably, the tiles are precast as a composite structural matrix of polyurea, and can alternatively comprise polyvinyl chloride, polyurethane or other construction materials that have desired properties.

Tiles can range in thickness from about one-quarter inch to about one inch or greater depending upon the intended characteristics. The tiles can be produced in a variety of sizes and shapes. A 2 ft.-by-2 ft. square is preferred because it is the easiest to handle and palletize for shipment and transport. Hardness can be selected. Desirable hardness is generally between approximately Shore Hardness 70A and approximately 95A. The upper surface of the tiles can be selected to be smooth or non-skid, depending upon the intended use. Those of ordinary skill in the art are aware that the top surface, preferably comprising aliphatic polyurea, can be customized with various finishes during the production process to provide additional protection from chemical exposures. Customer logos can be installed on the finish prior to actual installation of tiles at a job site.

The outer edge of each tile is designed to contain a notch or groove, preferably z-shaped, and alternatively semi-circular, so that when two tiles are placed adjacent to each other, a cavity is formed. A z-shaped notch or groove promotes the flow of joint or seam filler and creates a locking gasket around the tiles. The cavity formed by adjacent tiles is filed with flexible joint or seam filler to prevent intrusion of water or other liquids or contaminants. The flexible filler allows the tiles to expand and contract during temperature changes without compromising the seal between tiles.

The underside of the tiles preferably have a roughened finish and include angular troughs or channels to allow adhesive to enter the troughs or channels to promote adhesion of the bottom surface of a tile to the substrate. Preferably the troughs or channels are alternately angled in different directions to promote increased physical adhesion of the underside to the adhesive.

Joint or seam fillers can be selected from silicon, polyurea, and other suitable materials. Preferably, the filler material is flexible and resistant to chemical attack. The joint or seam filler, when cured, serves as a gasket that seals out and prevents moisture and other contaminants from reaching the underlying substrate. The joint or seam filler maintains adhesion by contracting and expanding within the area located between the tiles, maintaining flexibility and not hardening during changes in ambient surface and substrate temperatures.

Other changes and modifications will be apparent to one skilled in the art, and can be made without departing from the spirit and scope of the invention as defined in the appended claims.

I claim:

1. A composite tile comprising: a base portion and a top portion; the base portion having a plurality of end surfaces that define a perimeter of the base portion, and the base portion having a bottom surface; each end surface defining a groove that spans the perimeter of the base portion; the base portion comprising an aromatic polyurea resin or polyvinyl chloride; and the top portion comprising an aliphatic polyurea resin.

2. The tile according to claim 1, wherein the bottom surface defines channels for accepting adhesive to promote physical adhesion of the adhesive to the tile.

3. The tile according to claim 1, wherein the grooves are adapted for receiving joint or seam filler to seal an end surface of one tile to an end surface of an adjacent tile.

4. The tile according to claim 1, wherein the grooves are z-shaped or curvilinear notches.

5. The tile according to claim 1, wherein the grooves are disposed on the base portion nearer to the top portion than to the bottom surface.

6. A method for covering an existing substrate to repair, refurbish, reinforce or protect the substrate, the method comprising the acts of:
(a) preparing the substrate to accept a plurality of tiles, the tiles comprising a base portion comprising an aromatic polyurea resin or polyvinyl chloride, and a top portion comprising an aliphatic polyurea resin, the base portion having a plurality of end surfaces that define a perimeter of the base portion and also having a bottom surface, the end surfaces defining a groove, adapted to receive joint or seam filler, that spans the perimeter of the base portion;
(b) placing a multiplicity of the tiles on the substrate in a tiling arrangement;
(c) sealing adjacent tiles by filling the grooves of adjacent end surfaces with a seam filler.

7. The method according to claim 6, wherein the act of preparing the substrate includes priming the substrate.

8. The method according to claim 6, wherein the act of preparing the substrate includes filling a porous substrate with an epoxy filler.

9. The method according to claim 6, wherein the shapes of the tiles are selected to allow placement of the tiles to completely tile a selected portion of the substrate.

10. The method according to claim 6, wherein the tiles are adhered to the substrate.

11. A tile for covering an existing substrate to repair, refurbish, reinforce or protect the substrate, the tile comprising:
aromatic polyurea or polyvinyl chloride shaped to continuously tile a surface of the substrate, the tile having a plurality of end surfaces that define a perimeter and also having a bottom surface, the end surfaces defining a groove, adapted to receive joint or seam filler, that spans the perimeter.
